(19) United States
(12) Patent Application Publication
(10) Pub. No.: US 2007/0086220 A1
(43) Pub. Date: Apr. 19, 2007

(54) Circuit boards, power adapters and notebook computers for reducing EMI characteristics

(75) Inventors: Chiu-Hsien Chang, Taipei Hsien (TW); Chung-Yaw Su, Taipei Hsien (TW)

Correspondence Address: BACON & THOMAS, PLLC, 625 SLATERS LANE, FOURTH FLOOR, ALEXANDRIA, VA, 22314, US

(73) Assignee: Wistron Corporation, Taipei Hsien (TW)

(21) Appl. No.: 11/346,371

(22) Filed: Feb. 3, 2006

(30) Foreign Application Priority Data
Oct. 13, 2005 (TW) 094217714

(51) Int. Cl. H02M 3/335

(52) U.S. Cl. 363/21.16

(57) ABSTRACT

A circuit board for reducing EMI characteristics and a power adapter and a notebook computer having the circuit board are disclosed. The circuit board includes: a base board; an upper-site transistor having a power pin; and a lower-site transistor having a ground pin; wherein the upper-site transistor and the lower-site transistor are coupled to each other and placed next to each on the same side of the base board. The power pin and the ground pin are close to each other, and positions of the power pin and the ground pin form an angle that is substantially less than 90°.

### BACKGROUND OF THE INVENTION

1. Field of the Invention

The present invention relates to circuit boards, power adapters and notebook computers having power switches, and more particularly, to circuit boards, power adapters and notebook computers for reducing Electromagnetic Interference (EMI) characteristics.

2. Description of the Related Art

Power switches are common components applied in various electronic devices. In general, a power switch utilizes two industrial transistors, such as MOSFETs, to provide an oscillator for power conversion. However, when increasing the oscillation frequency (the working frequency of the components), these circuits usually also experience increased amounts of EMI; the resulting noise often exceeds the local legal standard, such as 30 dB.

Please refer to FIG. 1A. FIG. 1A shows a typical power switch that increases many solutions for EMI. Usually, the power switch 10 utilizes two transistors 11, 12, such as MOSFETs, and an inductor 15 that provides an inductance for the transistors 11, 12 so as to generate an oscillator for power conversion. The transistor 11, connected to a power point (such as the power provided by capacitors 14a-14c), is called an “upper-site” MOSFET, and the transistor 12 connected to a ground point is called a “lower-site” MOSFET. To increase the performance of the lower-site MOSFET 12, the lower-site MOSFET 12 is connected to a diode 13, which increases the performance of the lower-site MOSFET 12 and also increases the EMI characteristics.

The traditional power switch 10 may be disposed on a circuit board 2. Please refer to FIG. 1B. The circuit board 2 comprises a base board 22, the upper-site MOSFET 11, and the lower-site MOSFET 12. When placing the upper-site MOSFET 11 and the lower-site MOSFET 12 on the circuit board 2, a pin (which is usually the drain) of the upper-site MOSFET 11 for connecting to the power point and a pin (which is usually the source) of the lower-site MOSFET 12 for connecting to the ground point are disposed in opposite directions. Therefore, the loop between the upper-site MOSFET 11 and the lower-site MOSFET 12 is relatively long (which causes greater amounts of EMI noise). A capacitor 21 may be coupled between the upper-site MOSFET 11 and the lower-site MOSFET 12 as a solution for shortening the loop, but the EMI noise may still be too high. Therefore, many other solutions might be built into the circuit board 2 to comply with EMI standards (such standard may indicate, for example, that between radiation frequencies of 30 M˜230 MHz, the EMI noise must be less than 30 dB).

In order to satisfy the requirements of the EMI standard, the solutions for the traditional power switch 10, for example, include: coupling a resistor 18, 19 respectively on the gates of the upper-site MOSFET 11 and the lower-site MOSFET 12; adding a capacitor 20 between the gate of the lower-site MOSFET 12 and ground; coupling an inductor 16 to the lower-site MOSFET 12 before being grounded; and coupling a inductor 17 between the capacitors 14a-14c and the upper-site MOSFET 11.

As shown in FIG. 2, the curve CV1 shows the power switch 10 without any solutions. Usually, by adding the resistors 18, 19, the capacitor 20 and/or the inductor 16 to the power switch 10 can comply with EMI standards. However, the power switch of the present invention can dramatically reduce the noise, for example, down to below 30 dB, as shown as dotted line CV2.

However, for the circuit board 2, the placement of the upper-site MOSFET 11 and the lower-site MOSFET 12 causes high EMI noise and requires many solutions. All these components, like the resistors 18, 19, the capacitor 20 and/or the inductor 16 cause higher manufacturing cost and other problems such as higher operation temperature and lower performance.

Therefore, it is desirable to provide to circuit boards, power adapters and notebook computers for reducing EMI characteristics to mitigate and/or obviate the aforementioned problems.

### SUMMARY OF THE INVENTION

The present invention provides a circuit board, a power adapter and a notebook computer for reducing EMI characteristics. The circuit board comprises: a base board; an upper-site MOSFET having a power pin; and a lower-site MOSFET having a ground pin; wherein the upper-site MOSFET and the lower-site MOSFET are coupled to each other and placed next to each on the same side of the base board. The power pin and the ground pin are close to each other, and positions of the power pin and the ground pin form an angle that is substantially less than 90°. In the preferred embodiment, the angle formed between the power pin and the ground pin is substantially equal to 0°.

In an embodiment, the power pin and the ground pin are coupled together through a capacitor. Preferably, the capacitor has a capacitance of 0.1 μF.

In an embodiment, the circuit board further comprises an inductor, the upper-site MOSFET and the lower-site MOSFET are coupled to the inductor respectively.

In an embodiment, the circuit board further comprises a diode, and the diode is coupled to the lower-site MOSFET.

The circuit board of the present invention can be applied in a power adapter, the power adapter comprises: a power supply for providing power, the circuit board and the circuit board electrically connected to the power supply. Therefore, the circuit board can help the power adapter to have reduced EMI characteristics.

Furthermore, the circuit board of the present invention can be applied on a notebook computer. The notebook computer comprising: a display; an input device electrically connected to the display; a circuit board for controlling the input device and the display; and a housing. The housing covers the input device and the circuit board. The circuit board has a component, wherein, in an embodiment, the component is a processor requiring large current. In particular, the notebook computer utilizes the circuit board to conform to the applicable EMI standards.

An objective of the present invention is to provide a circuit board and its related applications capable of shortening the loop between the upper-site MOSFET and the lower-site MOSFET.

Another objective of the present invention is to provide a circuit board and its related applications for reducing EMI characteristics.

Another objective of the present invention is to provide a circuit board and its related applications with lower manufacturing cost.

Other objects, advantages, and novel features of the invention will become more apparent from the following detailed description when taken in conjunction with the accompanying drawings.

### BRIEF DESCRIPTION OF THE DRAWINGS

FIG. 1A shows a prior art power switch.

FIG. 1B shows placement of an upper-site MOSFET and a lower-site MOSFET of a power switch in a prior art circuit board.

FIG. 2 is a graph of noise versus frequency for a prior art power switch, and a noise versus frequency graph of a power switch of the present invention.

FIG. 3 shows a circuit board according to the present invention, and placement of an upper-site MOSFET and a lower-site MOSFET on the circuit board.

FIG. 4A-FIG. 4C provide top views of different embodiments for the placement of the upper-site MOSFET and the lower-site MOSFET on the circuit board shown in FIG. 3.

FIG. 4D is a side view of another embodiment for the placement of the upper-site MOSFET and the lower-site MOSFET on the circuit board shown in FIG. 3.

FIG. 4E is a top view of the placement for the upper-site MOSFET and the lower-site MOSFET on the circuit board shown in FIG. 3 after being rotated 90°.

FIG. 4F is a top view of another embodiment shown in FIG. 4A.

FIG. 5 shows a power switch according to FIG. 4A.

FIG. 6 is a function block drawing of the circuit board of the present invention as applied in a power adapter.

FIG. 7 is a perspective view of a notebook computer according to the present invention.

### DETAILED DESCRIPTION OF THE PREFERRED EMBODIMENT

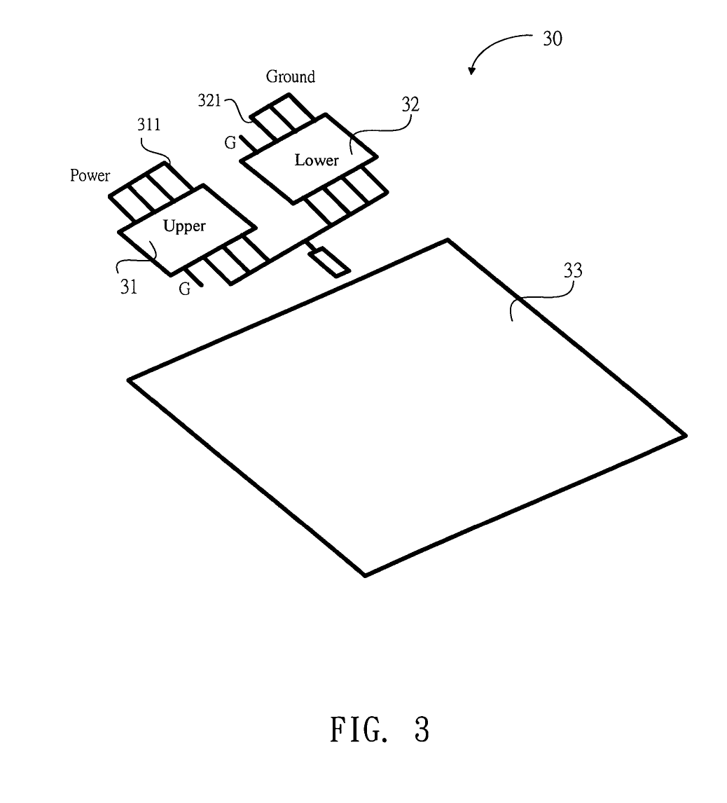

Please refer to FIG. 3. The present invention provides a circuit board 30 for reducing EMI characteristics. The circuit board 30 comprises a base board 33, an upper-site MOSFET 31, and a lower-site MOSFET 32. The upper-site MOSFET 31 has a power pin 311, and the lower-site MOSFET 32 has a ground pin 321. The power pin 311 and the ground pin 321 are placed close to each other.

The upper-site MOSFET 31 and the lower-site MOSFET 32 are coupled to each other and placed next to each other on the same side of the base board 33; the power pin 311 and the ground pin 321 are close to each other, and the positioning of the power pin 311 and the ground pin 321 form an angle. In this embodiment, the angle formed between the power pin 311 and the ground pin 321 is substantially equal to 0° (as shown in FIG. 3). In another words, the power pin 311 and the ground pin 321 are placed parallel to each other along the same direction, so that the loop between the upper-site MOSFET 31 and the lower-site MOSFET 32 is shortened, which leads to have less EMI noise.

As well known in the field of this technology, circuits of the upper-site MOSFET 31 and the lower-site MOSFET 32 can be formed by coating copper foil on the base board 33 so that a plurality of pins (including the power pin 311) provide the drain for the upper-site MOSFET 31 and are electrically connected to power (not shown); a plurality of pins (including the ground pin 321) provide the source, and be connected to ground (not shown). Therefore, it should be understood that the present invention imposes no limit on the shapes or designs of the power pin 311 and the ground pin 321.

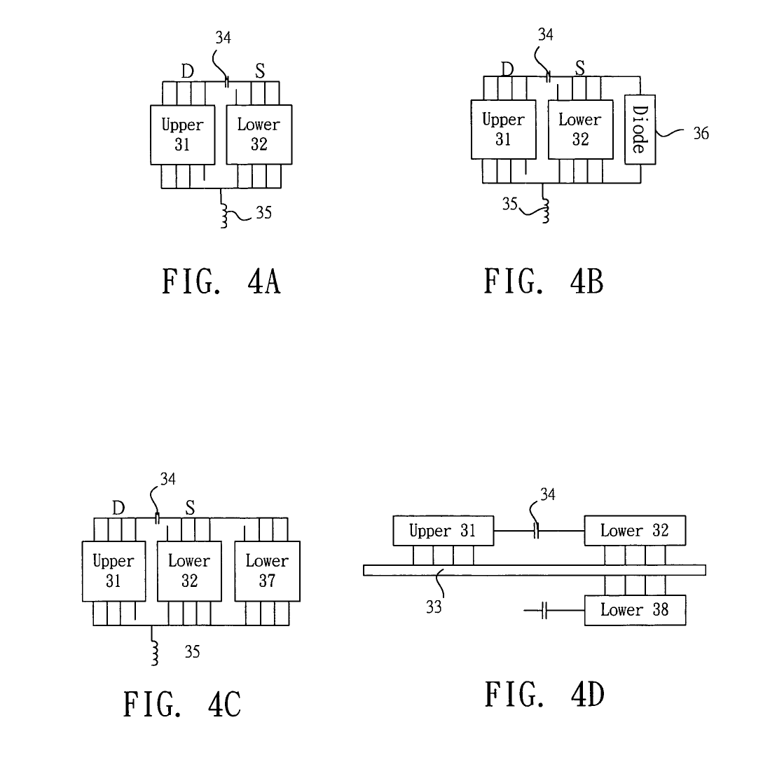

Please refer to FIG. 4A, which shows the placement of the upper-site MOSFET 31 and the lower-site MOSFET 32 on the circuit board 30 depicted in the embodiment of FIG. 3. In FIG. 4A, the power pin 311 and the ground pin 321 are coated with copper foil to form the drain D and the source S. In the embodiment shown in FIG. 4A, the drain D and the source S are coupled together with a capacitor 34. The capacitor 34 preferably has a capacitance of 0.1 μF, thereby to shorten the loop between the upper-site MOSFET 31 and the lower-site MOSFET 32.

In order to control circuit switching, the circuit board 30 further comprises an inductor 35, and the upper-site MOSFET 31 and the lower-site MOSFET 32 are coupled to the inductor 35.

Please refer to FIG. 4B; the circuit board 30 further comprises a diode 36. The diode 36 is coupled to the lower-site MOSFET 32 to increase the performance of the lower-site MOSFET 32 and to reduce EMI noise.

With further reference to FIG. 4C, the circuit board 30 may also be coupled to another lower-site MOSFET 37 next to the lower-site MOSFET 32. Similarly, to increase the total efficiency, the circuit board 30 can be configured to couple another upper-site MOSFET (not shown) and to couple the lower-site MOSFET 37 next to the upper-site MOSFET 31 and the lower-site MOSFET 32, respectively.

Please refer to FIG. 4D; the circuit board 30 shown in FIG. 4A can be coupled to another lower-site MOSFET 38 via a hole on the other side of the base board 33.

As shown in FIG. 4A to FIG. 4D, the circuit board 30 comprises the base board 33, with the upper-site MOSFET 31 and the lower-site MOSFET 32 disposed on the base board 33; the upper-site MOSFET 31 and the lower-site MOSFET 32 are placed next to each on the same side of the base board so that the angle formed between the power pin and the ground pin is equal to 0°.

Please refer to FIG. 4E. The angle formed between the power pin 311 (shown as the drain D in FIG. 4E) and the ground pin 321 (shown as the source S in FIG. 4E) can be 90°. That is, so long as the angle formed between the power pin 311 and the ground pin 321 is less than 90°, EMI may be reduced (for example, radiation frequency between 30 M-230 MHz has less than 30 dB of noise).

The upper-site MOSFET 31, the lower-site MOSFET 32 or other MOSFET (or industrial transistor) may be any type of transistor, and it may have different appearances due to different IC packaging configurations; for example, there are IC packages having 8 pins, 5 pins or 3 pins. Moreover, regardless of whether the upper-site MOSFET and lower-site MOSFET are one-phase, two-phase or three-phase, the present invention particularly considers the relative placement of the upper-site MOSFET 31 with the lower-site MOSFET 32.

Please refer to FIG. 4F. The upper-site MOSFET 41, having 3 pins, and the lower-site MOSFET 42, also having 3 pins, are shown; an angle between the power pin 411 of the upper-site MOSFET 41 and the ground pin 421 of the lower-site MOSFET 42 is less than 90° (in particular, the angle shown in FIG. 4F is 0°).

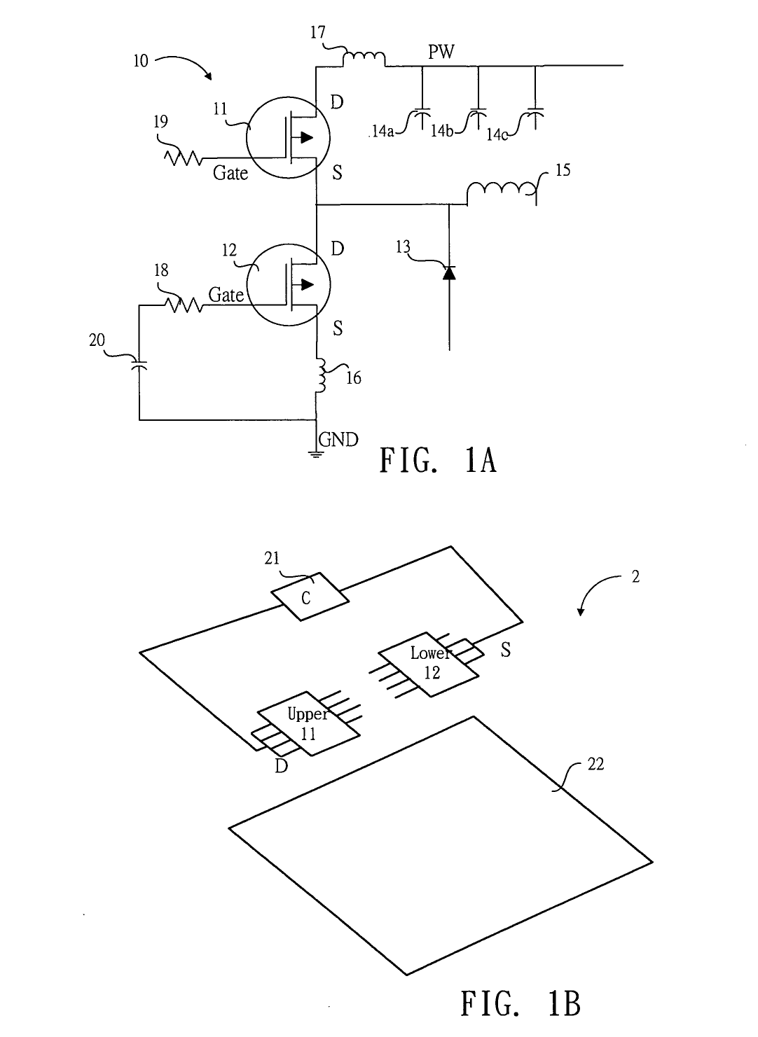

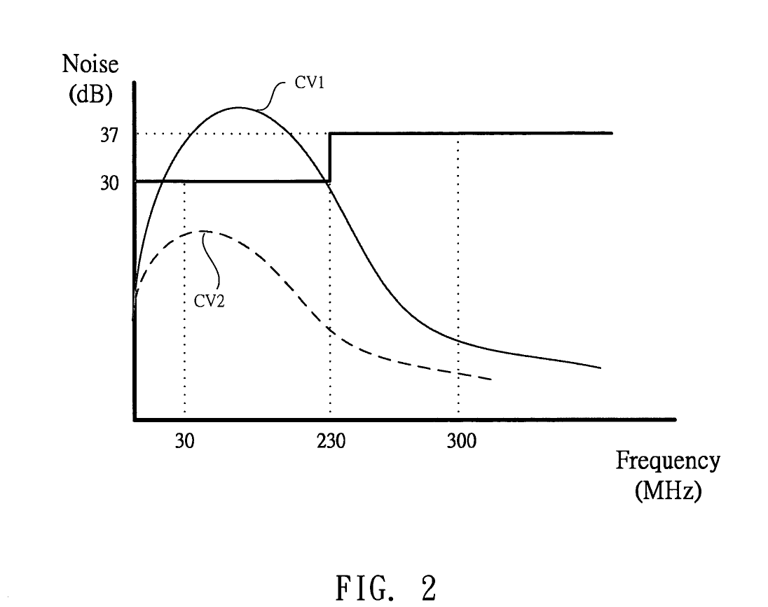

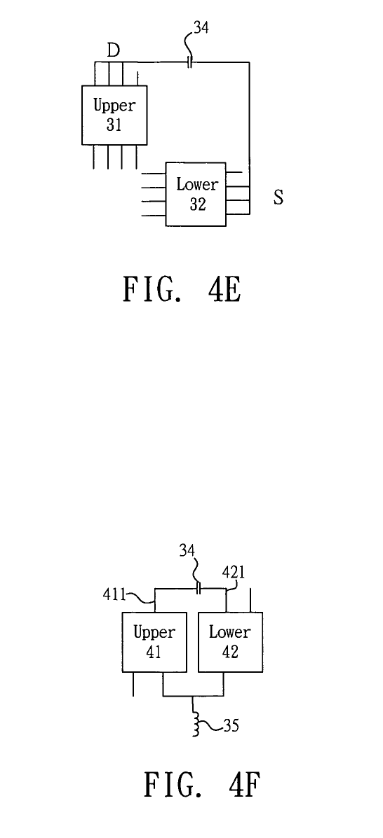

After measurement, when compared to the traditional circuit, the circuit board 30 of the present invention dramatically reduces EMI noise. For example, for radiation frequencies between 30 M-230 MHz, the EMI noise is less than 30 dB, and so no other noise reduction solutions are required. As shown in FIG. 5, when comparing the switch circuit 50 shown in FIG. 4A with the traditional power switch 10 shown in FIG. 1A, many noise-reduction components may be omitted, such as resistors, capacitors, and inductors. Therefore, the present invention dramatically reduces both the cost of the noise-reduction solution and the EMI noise.

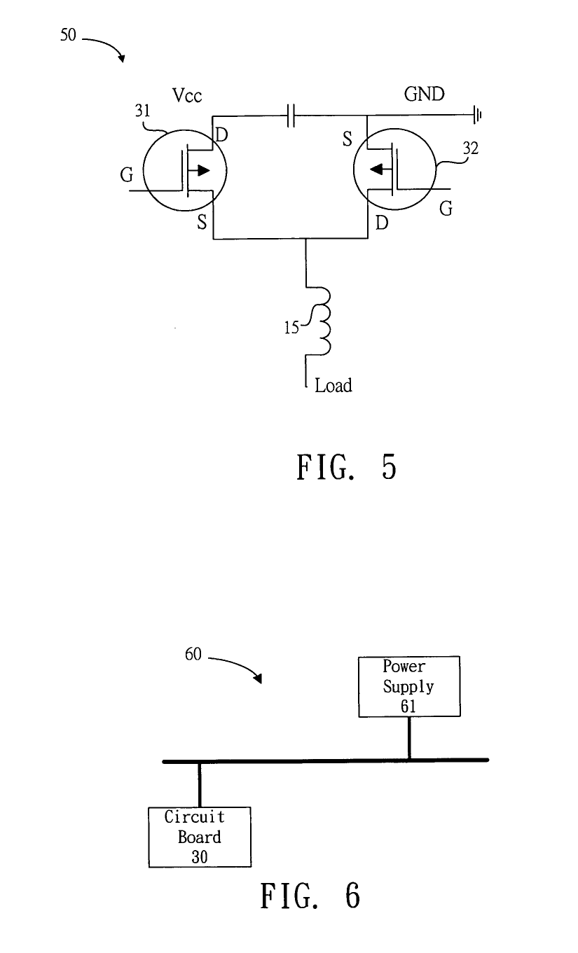

Please refer to FIG. 6; the circuit board 30 of the present invention may be utilized in a power adapter 60. The power adapter 60 comprises the circuit board 30 and a power supply 61 connected to the circuit board 30. The power supply 61 is used to provide power. The circuit board 30 reduces EMI noise in the power adapter 60.

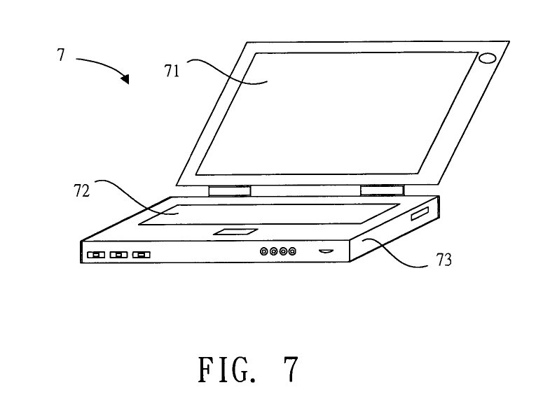

Moreover, as shown in FIG. 7, a notebook computer 7 may comprise a display 71, an input device 72, a housing 73 and the circuit board 30 (not shown in FIG. 7). The housing 73 covers the circuit board 30 and the input device 72. The circuit board 30 further comprises a component (not shown) that is utilized in the notebook computer; in this embodiment, the component may be a processor (or memory) requiring a larger current. In particular, the notebook computer 7 utilizes the circuit board 30 to conform with applicable EMI standards, such as having less than 30 dB of EMI noise between 30 M to 230 MHz. The circuit board 30 also reduces the temperature of components in the notebook computer 7, and improves the efficiency of the notebook computer 7.

Although the present invention has been explained in relation to its preferred embodiment, it is to be understood that many other possible modifications and variations can be made without departing from the spirit and scope of the invention as hereinafter claimed.

What is claimed is:

1. A circuit board comprising:
a base board;
an upper-site transistor having a power pin; and
a lower-site transistor having a ground pin;
wherein the upper-site transistor and the lower-site transistor are coupled to each other and placed next to each on the same side of the base board, the power pin and the ground pin are close to each other, and positions of the power pin and the ground pin form an angle that is substantially less than 90°.

2. The circuit board as claimed in claim 1, wherein the power pin and the ground pin are substantially aligned along the same direction, and the angle formed between the power pin and the ground pin is substantially equal to 0°.

3. The circuit board as claimed in claim 1, wherein the power pin and the ground pin are coupled together through a capacitor.

4. The circuit board as claimed in claim 3, wherein the capacitor has a capacitance of 0.1 μF.

5. The circuit board as claimed in claim 1 further comprising an inductor, the upper-site transistor and the lower-site transistor coupled to the inductor.

6. The circuit board as claimed in claim 1 further comprising a diode, and the diode is coupled to the lower-site transistor.

7. A power adapter comprising:
a power supply for providing power; and
a circuit board electrically connected to the power supply and comprising:
a base board;
an upper-site transistor having a power pin; and
a lower-site transistor having a ground pin;
wherein the upper-site transistor and the lower-site transistor are coupled to each other and placed next to each on the same side of the base board, the power pin and the ground pin are close to each other, and positions of the power pin and the ground pin form an angle that is substantially less than 90°.

8. The power adapter as claimed in claim 7, wherein the power pin and the ground pin are substantially aligned along the same direction, and the angle formed between the power pin and the ground pin is substantially equal to 0°.

9. The power adapter as claimed in claim 7, wherein the power pin and the ground pin of the circuit board are coupled together through a capacitor.

10. The power adapter as claimed in claim 9, wherein the capacitor has a capacitance of 0.1 μF.

11. The power adapter as claimed in claim 7, wherein the circuit board further comprises an inductor, the upper-site transistor and the lower-site transistor coupled to the inductor.

12. The power adapter as claimed in claim 7, wherein the circuit board further comprises a diode, and the diode is coupled to the lower-site transistor.

13. A notebook computer comprising:
a display;
an input device electrically connected to the display;
a circuit board for controlling the input device and the display; and
a housing covering the input device and the circuit board; wherein the circuit board comprises:
a base board;
a component mounted on the base board;
an upper-site transistor having a power pin; and
a lower-site transistor having a ground pin;
wherein the upper-site transistor and the lower-site transistor are coupled to each other and placed next to each on the same side of the base board, the power pin and the ground pin are close to each other, and positions of the power pin and the ground pin form an angle that is substantially less than 90°.

14. The notebook computer as claimed in claim 13, wherein the component is a component requiring large current.

15. The notebook computer as claimed in claim 14, wherein the component is a processor or a RAM.

16. The notebook computer as claimed in claim 13, wherein the power pin and the ground pin are substantially aligned along the same direction, and the angle formed between the power pin and the ground pin is substantially equal to 0°.

17. The notebook computer as claimed in claim 13, wherein the power pin and the ground pin of the circuit board are coupled together through a capacitor.

18. The notebook computer as claimed in claim 17, wherein the capacitor has a capacitance of 0.1 μF.

19. The notebook computer as claimed in claim 13, wherein the circuit board further comprises an inductor, the upper-site transistor and the lower-site transistor coupled to the inductor.

20. The notebook computer as claimed in claim 13, wherein the circuit board further comprises a diode, and the diode is coupled to the lower-site transistor.
